(19) United States
(12) Patent Application Publication
(10) Pub. No.: US 2009/0020305 A1
(43) Pub. Date: Jan. 22, 2009

(54) MODULAR CONDUIT-BRIDGING RAMP AND COUPLINGS FOR ELECTRICAL CONDUITS

(75) Inventor: Aaron Stewart FIDLER, Hong Kong (CN)

Correspondence Address: LEYDIG VOIT & MAYER, LTD, 700 THIRTEENTH ST. NW, SUITE 300, WASHINGTON, DC, 20005-3960, US

(73) Assignee: PRIME CAPITAL HOLDINGS LTD., Belize City (BZ)

(21) Appl. No.: 11/779,420

(22) Filed: Jul. 18, 2007

(51) Int. Cl. H01J 5/00

(52) U.S. Cl. 174/50; 14/69.5

(57) ABSTRACT

A modular assembly for bridging elongate conduits includes two ramps which define a conduit-receiving channel between them. A bridge member overlies each of the ramps, spanning the conduit-receiving channel. A link member joins the two ramps in side-by-side relationship. To allow the width of the conduit-receiving channel to be varied, connectors are provided on the sides of the link member for engaging any one of complementary connectors at spaced positions on the ramps. Couplers for joining electrical cables include a device for providing a visual indication of the current in the cables. A coupling system for connecting electrical couplers engaged by a push-turn action includes a sleeve received in a recess between the couplers for engaging resilient seals on each coupler urging the engaged electrical contacts apart, thereby improving security of the connection.

### TECHNICAL FIELD

The present invention relates to conduit-bridging ramps for protecting conduits from traffic and particularly to ramps which can be assembled in a modular manner. The invention also relates to couplings for joining electrical conduits.

### BACKGROUND OF THE INVENTION

Conduit-bridging ramps are used to allow vehicle and pedestrian traffic to safely pass over ground-supported conduits, while avoiding damage to the conduits from traffic loads. Conventionally these ramps include one or more longitudinal channels for receiving the conduits (which may be electrical cables, hoses and the like). Tapered transverse edges extend outward from both sides of the channel to allow wheels to run smoothly over the ramp. End connectors may be provided so that ramps can be connected end-to-end in a modular manner to span any required length.

In some prior art designs the channel is formed as a recess opening at the base of the ramp, so that adding additional conduits requires removing the ramps. The conduits are supported directly upon the ground and so may be subject to stress and abrasion, and the conduits are liable to be crushed if not carefully aligned before the ramp is placed over them.

To provide the minimum obstruction to traffic these ramps should have a minimum transverse dimension. However with these conventional conduit-bridging ramps, in some circumstances it can become necessary, in order to accommodate an increased number of conduits, to provide two or more sets of parallel ramps. This creates an uneven surface for vehicles or pedestrians crossing the ramps.

It will therefore be understood that there is a need for a modular conduit-bridging ramp that can accommodate a variable size or number of conduits, for use when additional conduit capacity must be added after installation or when the conduit capacity needed is unknown initially, and which provides a structure with a relatively uniform traffic-supporting surface. The ramp should also reduce the opportunity of the conduits to be stressed in use.

In connecting remote electrical loads temporarily, lengths of cable with plug-and-socket type connectors are commonly used. In many such applications it is desirable to have some indication of the electrical current being drawn through a particular cable, perhaps when assessing the available capacity when adding a further load. Connecting an ammeter between two couplers may be time consuming, while an ammeter permanently connected at an intermediate position in the cable increases the bulk of the cable assembly and provides an obstruction—it may for instance prevent the cable being wound up for storage. It is therefore an object of the invention to allow a cable assembly to be produced which can more readily provide an indication of the electrical current being drawn, while mitigating any additional obstruction.

In certain environments where plug-and-socket type connectors are used it is desirable to seal the connectors, for instance in the marine environment seals are commonly provided on electrical connectors to protect against the ingress of potentially corrosive atmosphere to the vulnerable electrical contacts. In a common marine industry telephone line connector joined by a push-turn action, and used for temporary connection between a vessel and terminal on the berth, seals are fixed to both the male plug and female socket connectors and these cooperate with fittings on the vessel and berth to provide a satisfactory seal. However if it is necessary to join two such cables end-to-end using these connectors, the resulting connection is unsatisfactory as it is not particularly secure and the seals do not cooperate to seal the connectors.

### DISCLOSURE OF THE INVENTION

According to one aspect of the present invention there is provided a modular assembly for bridging elongate conduits comprising:

two ramps;

a bridge member for transversely spanning a conduit-receiving channel between the ramps, the bridge member having a traffic-supporting surface and first and second transverse sides, at least the first transverse side overlying a supporting face of one of the ramps;

a link member for joining the two ramps in a side-by-side relationship, the link member having first and second transverse sides, connectors provided on at least the first side of the link member for engaging any one of a plurality of complementary connectors at spaced positions on a first of the ramps whereby with the second side of the link member fastened to a second of the ramps the ramps can be connected together at any one of a plurality of transverse spacings to vary the width of the conduit-receiving channel.

Preferably the connectors are provided on both of the first and second sides of the link member and both the ramps are of like construction and include complementary connectors at spaced positions such that the transverse position of both ramps can be varied relative to the link member to vary the width of the conduit-receiving channel.

The connectors on the link member preferably comprise projections and the complementary connectors comprise recesses for receiving the projections. Most preferably the recesses are provided in a base of each ramp, and the mouth of the recess opens toward a lower ground-engaging face of the ramp.

Optionally the bridge member may be formed integrally with, or fixed to, one of the two ramps. Preferably the bridge member is moveable independently of either ramp for access to the conduits. Preferably both the transverse sides of the bridge member are configured to overlay the supporting face of each ramp, each supporting face having corrugations of a pitch substantially equal to the spacings between the complementary connectors, and the first and second sides of the bridge member have abutments complementary to the corrugations. The traffic-supporting surface of the bridge member is preferably convex.

Preferably each ramp includes complementary male and female couplings at the longitudinal ends thereof for coupling adjacent ramps end-to-end, each ramp having a substantially planar abutting end faces at its longitudinal ends, the female coupling being recessed in the end face and the male coupling being pivotably mounted to the ramp for movement between a stored position where it is retracted inside the end face and an extended position where it projects outwardly from the end face for use.

This invention provides a conduit-bridging assembly which is effective and efficient in operational use, and which has an overall simple design which minimizes manufacturing costs. It offers an essentially modular design, which not only allows the length to be varied to suit the need, but allows the conduit-carrying capacity to be varied after installation. Increases in conduit-carrying capacity are achieved with negligible effect on obstruction to traffic.

In another aspect there is provided an electrical coupling comprising:

a housing having a cavity;

a plug or socket connector fixed to the housing;

an electrical conduit connected to the plug or socket connector;

an electrical current sensor in the cavity for sensing current flowing in the conduit;

a control circuit in the cavity electrically connected to the current sensor;

a plurality of light emitters mounted in the cavity each light emitter electrically connected to the control circuit, each light emitter directing light through a respective window in the housing, the windows being substantially aligned,

whereby the control circuit actuates the light emitters to provide a visual indication of the current sensed in the conduit.

Preferably the control circuit progressively illuminates light emitters until the current reaches a rated current capacity of the conduit at which all of the light emitters are illuminated. Optionally the current sensor may be a non-contact sensor and the control circuit may be powered inductively.

In a still further aspect there is provided an electrical coupling system comprising:

male and female couplers joined by a push-turn action, each coupler having an axis,

the male and female couplers having respective first and second abutment faces lying in radially aligned planes, a peripheral recess about the abutment face and a resilient annular seal in the recess;

the male coupler having a plurality of male coupler electrical contacts protruding in the axial direction from the first abutment face, each male coupler contact having a radially protruding shoulder;

the mating female coupler having cavities in the second abutment face for receiving each of the protruding contacts in the axial direction, female coupler electrical contacts in each cavity engaging each shoulder upon relative rotation between the couplers to mechanically connect the couplers, and

a collar adapted for connection between the male and female couplers in which position it is received in received in the recess in each coupler, the collar having two opposing annular faces for contacting and compressing the seals on the male and female couplers for urging the mechanically connected couplers apart.

### BRIEF DESCRIPTION OF THE DRAWINGS

Preferred forms of the present invention will now be described by way of example with reference to the accompanying drawings, wherein:

FIG. 1a is a pictorial view of an assembly of the present invention for bridging elongate conduits;

FIG. 1b is a fragmentary view showing the base of the assembly of FIG. 1a;

FIG. 2 is an exploded view of truncated sections of the assembly of FIG. 1;

FIG. 3 is a transverse cross section through the assembly of FIG. 1a with the ramp 1a in an extended position;

FIG. 4 is a first embodiment of an electrical connector of the invention;

FIG. 5 is a schematic of the connector of FIG. 4;

FIG. 6 is a exploded view of a second embodiment of an electrical connector of the invention, and

FIG. 7 is a partially sectioned side elevation of the components of FIG. 6 as connected in use.

### DESCRIPTION OF THE PREFERRED EMBODIMENTS

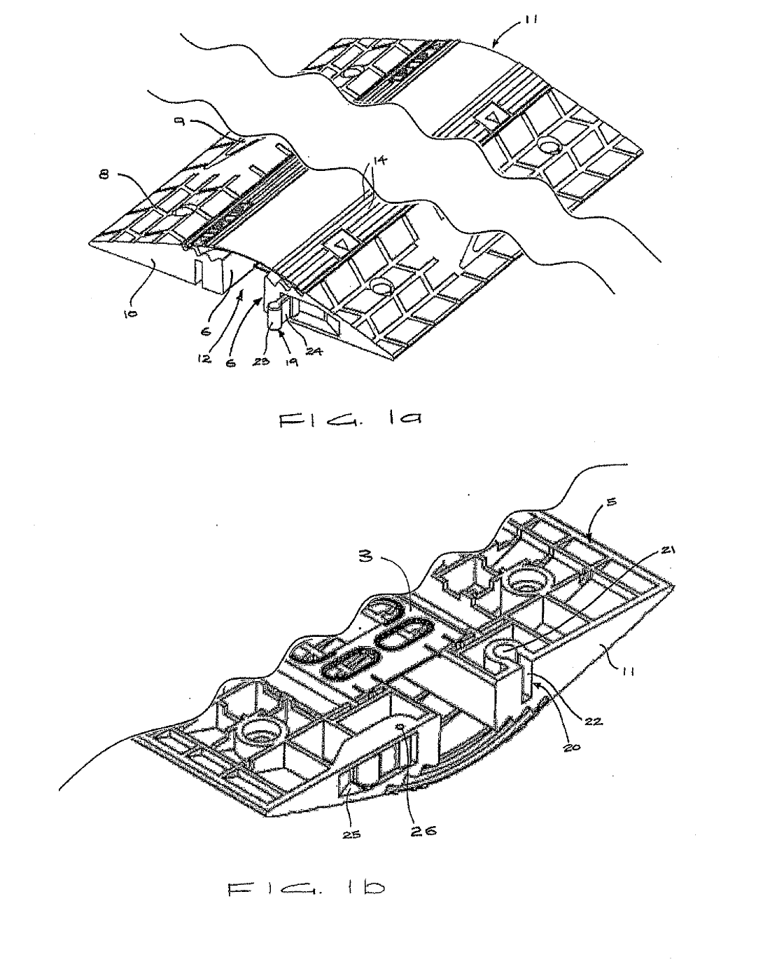

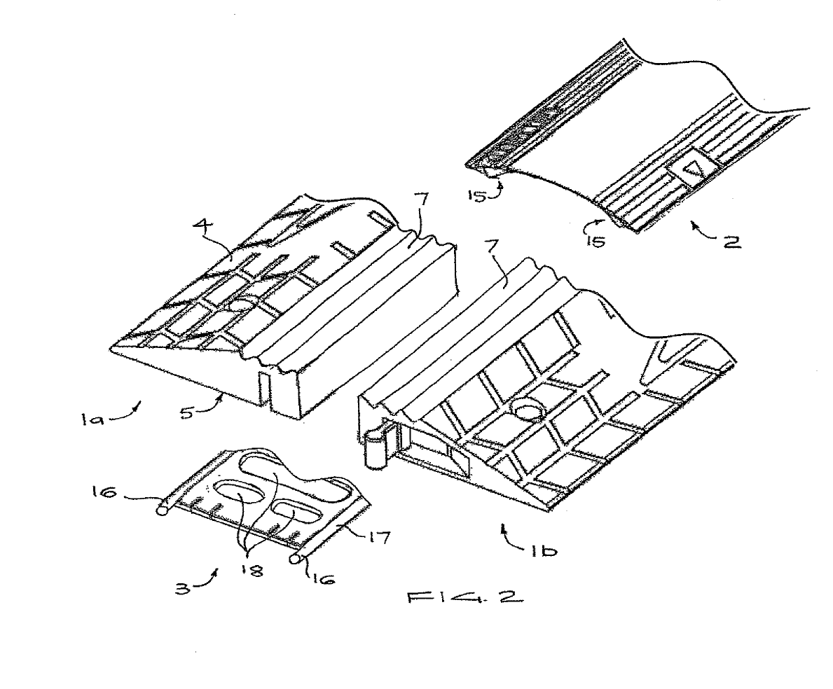

Referring to the drawings, FIGS. 1 to 3 illustrate an embodiment of a modular assembly for bridging elongate conduits generally including two ramps 1a, 1b, a bridge member 2 and a link member 3. The ramps 1a, 1b are of like construction, each is tapered with an inclined ramp surface 4, a ground-supported base 5, an inner lateral surface 6, an outwardly facing corrugated face 7 and longitudinally opposing end faces 10, 11. The ramp surface 4 is made uneven with grooves 8 to increase traction and includes warning indicia 9.

The ramps 1a, 1b are elongate and the bridge member 2 has the same length, providing modularity of the assembly. The longitudinally extending channel 12 for receiving the conduits (not shown) is bounded laterally between the surfaces 6 and vertically between the link member 3 and bridge member 2.

The bridge member 2 has a convex outer traffic-supporting surface 13 with grooves 14 extending adjacent its longitudinal edges for traction. The corrugations 16 formed in the faces 7 are elongated in the longitudinal direction and have a pitch dimension x. The inner surface of the bridge member 2 has abutments 15 of complementary form to the corrugations 16 at both its transverse sides which overly the faces 7.

The link member 3 is elongate, but of shorter length than the ramps and bridge member. At both longitudinal ends of the link member 3, on transversely opposing sides are longitudinally-extending projections 16 having a cylindrical outer surface. The projections 16 are formed integrally with elongate ribs 17 extending lengthwise along each edge of the link member 3 and upon which the link member 3 is supported upon the ground. A plurality of voids 18 are provided in the link member 3 to reduced its weight.

The inner part of the base 5 is recessed to receive the link member 3, with longitudinally aligned recesses 17 at opposing ends for receiving the projections 16. The recesses 17 are spaced at dimension x, the same pitch as that of the corrugations 16. The mouth of each recess 17 opens toward the base 5.

The link member 3 serves to join the two ramps 1a, 1b in a side-by-side relationship, at a plurality of spacings with each ramp being moveable (between the positions relative to the bridge member 2 and link member 3) in order to vary the width of the channel 12. The link member 3 also supports the cables, preventing abrasion or other damage from contact with the ground.

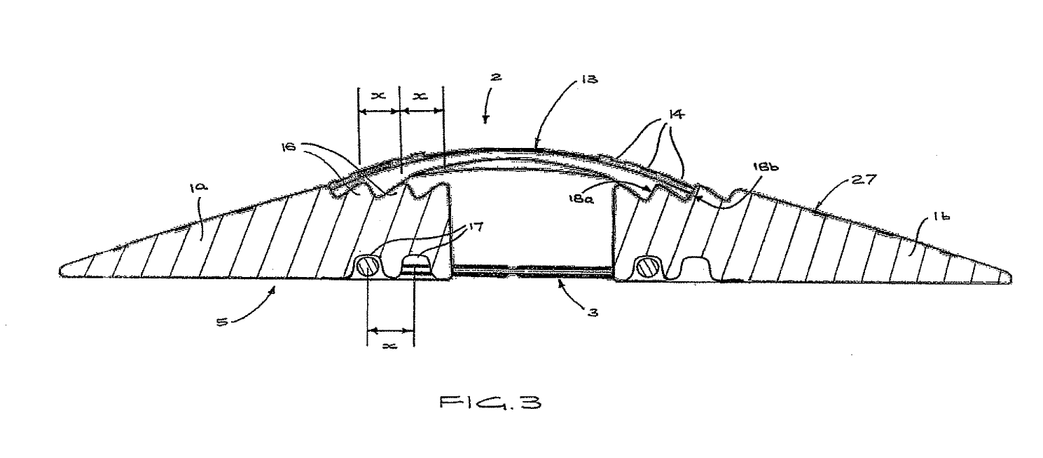

In FIG. 3 the ramp 1a is shown at its innermost lateral position and the ramp 1b at its outermost lateral position in which part of the corrugated surface 7 is exposed between the traffic-supporting surface 13 and the inclined surface 27 of the ramp.

Due to the size of the corrugations 16, this exposed section presents a negligible obstacle to foot or wheeled traffic. In use the bridge member transversely spans the channel 12 and flexure of the bridge member under traffic tends to push the abutments 15 apart, however this tendency is reacted by the link member 3 and the cooperation between the mating inclined faces 18a, 18b on the corrugations 16 and abutments 15, thereby resisting flexure of the bridge member 2 and separation of the ramps 1a, 1b.

As best seen in FIGS. 1a and 1b, complementary male and female couplings 19, 20 are provided at the longitudinal ends of each ramp 1a, 1b for coupling adjacent ramps end-to-end. The parallel end faces 10, 11 are generally upright and abutting when then the ramps are connected. The female coupling 20 opens toward the base 5 and includes a head portion 21 and neck portion 22, the neck portion is recessed through the face 11. The male coupling 19 has a head 23 and neck 24 of complementary shape to the female coupling 20. The male coupling 19 is mounted by an upright pivot 26 for movement between a stored position (FIG. 1b) where it is retracted inside a cavity 25 in the end face and an extended position (FIG. 1a) where it projects outwardly from the end face for use.

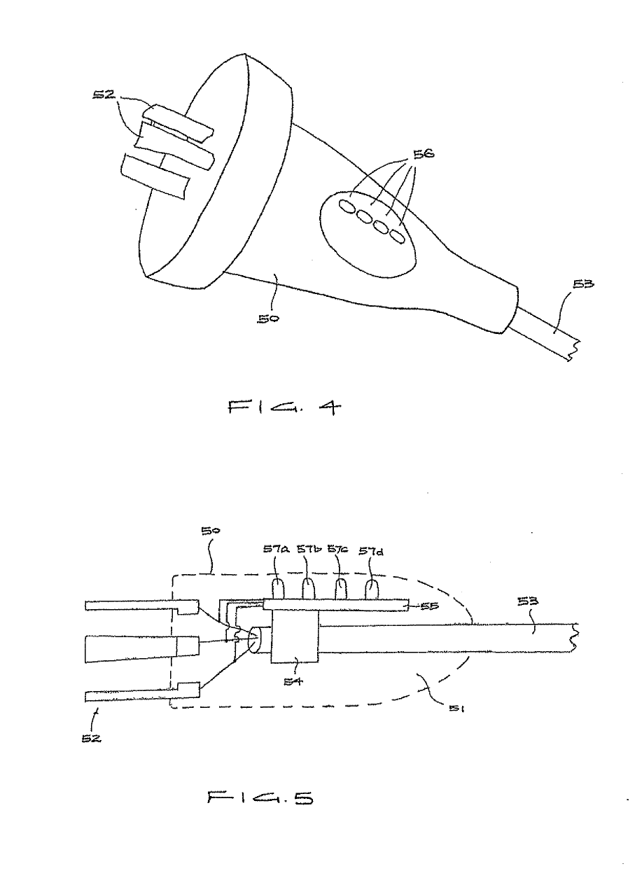

FIGS. 4 and 5 show a first embodiment of an electrical connector according to the invention, having a housing 50 enclosing a cavity 51. Electrical contacts 52 are fixed to the housing and protrude from one end, with a power cable 53 extending through the housing 50 to protrude from the opposing end. The cable 53 passes through an inductive sensor 54 electrically connected to a control circuit board 55. Four light-emitting diodes 57a-57d are mounted in a line to the control circuit board 55. Each LED 57a-57d is adjacent a respective window 56 in the housing, through which it directs light.

With a cable having a 10 amp rated capacity, all of the LEDs 57 are illuminated when a current above about 9.5 amps is sensed. As the current increases from nothing LED 57d is first illuminated when the sensed current exceeds 2.5 amps, followed by LEDs 57c and 57b as 5 amps and 7.5 amps are exceeded respectively. After installation of the components into the housing 50, the cavity 51 may be filled to encapsulate the circuit board 55, for impact protection.

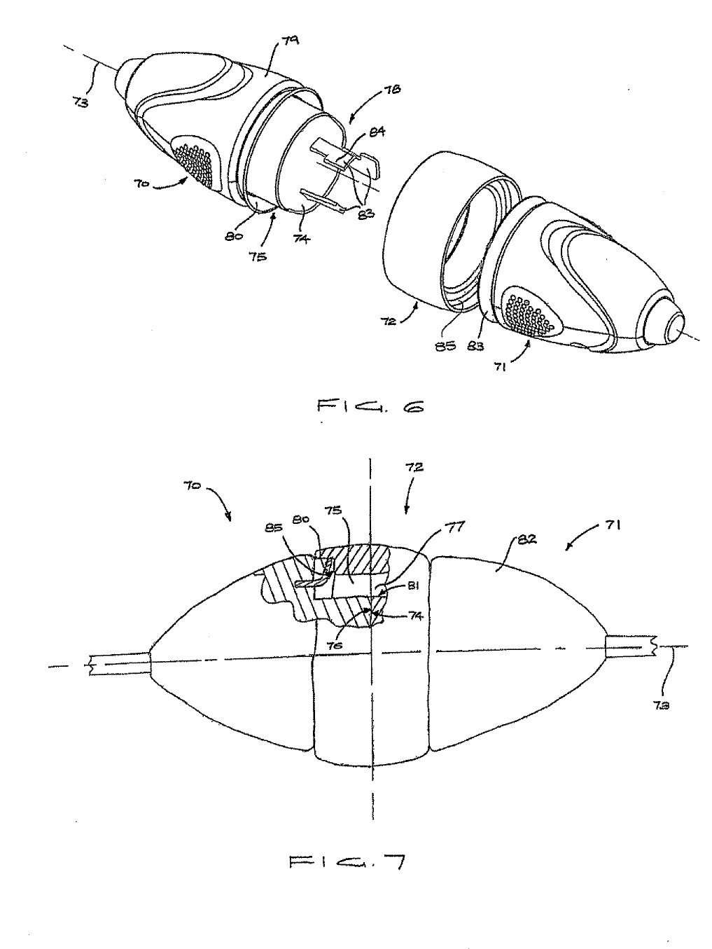

As seen in FIGS. 6 and 7, a second embodiment of a coupling system for joining electrical conductors or cables includes male and female couplers 70, 71 and a collar 72 which are generally symmetrical about axis 73. The couplers 70, 71 are adapted to be connected to the ends of an electrical cable (not shown). The male coupler 70 has a radially aligned abutment face 74 formed on the outermost end of a cylindrical protrusion 78, having a smaller diameter than the adjacent body portion 79 which provides a recess 75 about the abutment face 74. A resilient annular seal 80 is mounted in the recess 75 has a frustoconical projecting lip tapering outwardly toward the abutment face 74. Similarly, the female coupler 71 has a radially aligned abutment face 76 formed on the outermost end of a cylindrical protrusion 81, having a smaller diameter than the adjacent body portion 82 which provides a recess 77 about the abutment face 76. A resilient annular seal 83 is mounted in the recess 77 has a frustoconical projecting lip tapering outwardly toward the abutment face 76. Power is provided to the control circuit 55 and for powering the sensor 54 and LEDs by direct connection the conductors within the cable 53.

The male coupler has three electrical contacts 83 protruding in the axial direction from the abutment face 74, each contact 83 having a radially protruding shoulder 84. The mating female coupler has cavities in the second abutment face 76 for receiving each of the protruding contacts in the axial directions.

The male and female couplers 70, 71 are joined by a push-turn action, for instance the electrical contacts 83 are entered into the female coupler 71 in the axial direction before turning the male coupler 70 about the axis 73. When turned in this manner the shoulders 84 are engaged with the female coupler 71 to prevent separation of the couplers.

The collar 72 is received in the recesses 75, 77 and has two opposing annular faces 85 for contacting and compressing the seals 80, 83. The seals 80, 83 thus not only seal the coupling assembly against the ingress of liquid or foreign matter, but the resilient action of the seals 80, 83 urges the couplers and engaged electrical contacts apart, thereby improving the security of the engagement between the electrical contacts.

Aspects of the present invention have been described by way of example only and it should be appreciated that modifications and additions may be made thereto without departing from the scope thereof.

1. A modular assembly for bridging elongate conduits comprising:
two ramps;
a bridge member for transversely spanning a conduit-receiving channel between the ramps, the bridge member having a traffic-supporting surface and first and second transverse sides, at least the first transverse side overlying a supporting face of one of the ramps; and
a link member for joining the two ramps in a side-by-side relationship, the link member having first and second transverse sides, connectors located on at least the first side of the link member for engaging any one of a plurality of complementary connectors at spaced positions on a first of the ramps, whereby, with the second side of the link member fastened to a second of the ramps, the ramps can be connected together at any one of a plurality of transverse spacings to vary width of the conduit-receiving channel.

2. The assembly of claim 1 wherein
the connectors are located on both of the first and second transverse sides of the link member, and
both of the ramps are of like construction and include complementary connectors at spaced positions such that transverse positions of both ramps can be varied relative to the link member to vary the width of the conduit-receiving channel.

3. The assembly of claim 2 wherein the connectors on the link member comprise projections and the complementary connectors on each of the ramps comprise recesses for receiving the projections.

4. The assembly of claim 3 wherein the recesses are located in a base of each ramp, and each recess has a mouth opening toward a lower, ground-engaging face of the ramp.

5. The assembly of claim 1 wherein the bridge member is moveable independently of either ramp for access to the conduits.

6. The assembly of claim 2 wherein
both of the first and second transverse sides of the bridge member are configured to overlay the supporting face of each ramp, each supporting face having corrugations of a pitch substantially equal to spacings between the spaced positions of the complementary connectors, and
the first and second transverse sides of the bridge member have abutments complementary to the corrugations.

7. The assembly of claim 1 wherein each ramp includes complementary male and female couplings at longitudinal ends of the ramps for coupling adjacent ramps end-to-end, each ramp having a substantially planar abutting ends face at the longitudinal ends, the female coupling being recessed in the end face and the male coupling being pivotably mounted to the ramp for movement between a stored position, retracted inside the end face, and an extended position projecting outwardly from the end face.

8. An electrical coupling comprising:
a housing having a cavity;
a plug or socket connector fixed to the housing;
an electrical conduit connected to the plug or socket connector;
an electrical current sensor in the cavity for sensing current flowing in the conduit;
a control circuit in the cavity electrically connected to the current sensor; and
a plurality of light emitters mounted in the cavity, each light emitter being electrically connected to the control circuit, each light emitter directing light through a respective window in the housing, the windows being substantially aligned, whereby the control circuit actuates the light emitters to provide a visual indication of the current sensed in the conduit.

9. The coupling of claim 8 wherein the control circuit progressively illuminates light emitters until the current reaches a rated current capacity of the conduit at which all of the light emitters are illuminated.

10. An electrical coupling system comprising:
male and female couplers joined by a push-turn action, each coupler having an axis, the male and female couplers having respective first and second abutment faces lying in radially aligned planes, a peripheral recess about each abutment face, and a resilient annular seal in each recess, wherein
the male coupler has a plurality of male coupler electrical contacts protruding in an axial direction from the first abutment face, each male coupler contact having a radially protruding shoulder, and
the female coupler, has cavities in the second abutment face for receiving each of the male coupler contacts in the axial direction, female coupler electrical contacts in each cavity engaging each shoulder upon relative rotation between the male and female couplers to mechanically connect the male and female couplers, to each other; and
a collar for connection between the male and female couplers the collar being received in the recess in each male and female coupler, the collar having two opposing annular faces for contacting and compressing the seals on the male and female couplers, thereby urging the male and female connections, when mechanically connected apart.
